(19) United States
(12) Patent Application Publication
(10) Pub. No.: US 2012/0275550 A1
(43) Pub. Date: Nov. 1, 2012

(54) METHOD FOR DETECTING S-SCH IN CELL SEARCHING AND RECEIVER USING THE SAME

(75) Inventors: Young Seok Baek, Daejeon (KR); Bon Tae Koo, Daejeon (KR); Jung-ho Myung, Daejeon (KR); Joonhyuk Kang, Daejeon (KR)

(73) Assignees: Korea Advanced Institute of Science and Technology, Daejeon (KR); Electronics and Telecommunications Research Institute, Daejeon (KR)

(21) Appl. No.: 13/457,393

(22) Filed: Apr. 26, 2012

(30) Foreign Application Priority Data
Apr. 28, 2011 (KR) 10-2011-0040132
Apr. 23, 2012 (KR) 10-2012-0042265

(51) Int. Cl. H04B 1/06

(52) U.S. Cl. 375/343

(57) ABSTRACT

Disclosed is a method for detecting S-SCH in cell searching including: detecting an m0 value corresponding to an even index in a secondary synchronization channel (S-SCH) signal having an even index; determining an m1 group defined by the m0 value; detecting an m1 value using correlation detection relation within the m1 group; and detecting a group ID using the m0 value and the m1 value.

### CROSS-REFERENCES TO RELATED APPLICATIONS

The present application claims priority under 35 U.S.C 119(a) to Korean Application No. 10-2011-0040132, filed on Apr. 28, 2011, in the Korean Intellectual Property Office and Korean Application No. 10-2012-0042265, filed on Apr. 23, 2012, in the Korean Intellectual Property Office, which is incorporated herein by reference in its entirety set forth in full.

### BACKGROUND

Exemplary embodiments of the present invention relate to a method for detecting an S-SCH in cell searching, and a more particularly, to a method for detecting an S-SCH in cell searching capable of reducing computation complexity for detecting the S-SCH by extracting an m1 value based on correlation between an m0 value and the m1 value in a 3GPP LET synchronization channel and a receiver using the same.

LTE that is the acronym for Long Term Evolution is a radio communication technology that has been researched as fourth-generation mobile communication in the 3^{rd} generation partnership project (3GPP).

In order to construct communication environment between a base station and a terminal in general radio communication environment, data information, or the like, for synchronization between the base station and the terminal and analyzing packets needs to be previously constructed. In the LTE, the process is referred to as a cell search. A cell identification (ID) value informing the synchronization between the base station and the terminal and which region the terminal belongs to can be obtained by the cell searching.

In the process of extracting the existing cell ID value, several steps are present. Among those, an intermediate process of extracting a group ID using a sequence referred to as a secondary synchronization channel (S-SCH) is present. As the most common method, there is a method of obtaining a sequence having the highest correlation using cross-correlation between all types of sequences included in the S-SCH and the received sequence to extract the group ID.

However, in the LTE, the types of sequences that may be included in the S-SCH correspond to a total of 168, wherein each sequence is configured of symbols having 62 in length. Therefore, when using cross-correlation for all the cases, the computation complexity in the terminal is increased.

The existing method of detecting S-SCH uses the cross-correlation between all the 168 S-SCH sequences and the received sequences to detect the S-SCH sequence having the highest correlation.

In the following Equation 1, if the received S-SCH sequence having 62 in length is set to be rx_S-SCH, all type of S-SCH sequences is set to be tx_S-SCH, an index i value of the S-SCH sequence may be searched by the following Equation 1 to obtain the group ID.

$$i = {argmax}_{i , i ∈ [ 0 , 167 ]} \vert {\sum }_{l = 0}^{61} rx\_S - SCH ( l ) \times tx\_S - SCH ( i , l ) \vert \qquad [ Equation 1 ]$$

In the above Equation, i that is a figure of the sequence that may be included in the S-SCH represents 0 to 167 and 1 represents a symbol number corresponding to the length of the S-SCH sequence.

However, the method for detecting S-SCH uses the cross-correlation for all the 168 S-SCH sequences to detect the S-SCH sequence having the highest correlation, thereby greatly increasing the computation complexity.

To this end, a technology of detecting a coherent based S-SCH that allocates P-SCH and the S-SCH to several adjacent OFDM symbols and transmits the allocated P-SCH and S-SCH has been described. A structure of a receiver therefore is illustrated in FIG. 1.

FIG. 1 illustrates a block configuration diagram of the receiver for detecting S-SCH in accordance with the related art.

Since the P-SCH detection is basically performed prior to the S-SCH detection, the coherent detection uses a channel value estimated from the P-SCH to perform the channel compensation and then, the S-SCH detection.

First, a channel compensator compensates for the S-SCH receive signal R_{P-SCH}[k] in the frequency domain by using H_{P-SCH}[k] estimated from the P-SCH represented by the following Equation 2 in the receive signal subjected to fast Fourier transform by a fast Fourier transform (FFT). Here, k means a frequency domain subcarrier index.

R_{S-SCH}[k]=R_{S-SCH}[k]H*_{P-SCH}[k] [Equation 2]

An inverse process of the subcarrier allocation is performed in a demultiplexer after the channel compensation and a descrambler performs a descrambling process. In this case, the descrambled signal is represented by the following Equation 3. Here, 1 means an index of the descrambled signal.

aₘ_{₀}[l]=R_{S-SCH}[2k]c₀[k]

aₘ_{₁}[l]=R_{S-SCH}[2k+1]c₁[k]z₁^{(m}^{₀}[k] [Equation 3]

A correlator performs correlation between the descrambled signals aₘ_{₀}[l], aₘ_{₁}[l] and each reference signal and can detect the cell ID group from m₀, m₁ values detected represented by the following Equation 4 from the correlation output.

$${m}_{0} = {argmax}_{i} \vert {\sum }_{l = 0}^{{N}_{i} - 1} {a}_{{m}_{0}} [ l ] {s}^{( i )} [ l ] \vert \\ {m}_{1} = {argmax}_{i} \vert {\sum }_{l = 0}^{{N}_{i} - 1} {a}_{{m}_{1}} [ l ] {s}^{( i )} [ l ] \vert \qquad [ Equation 4 ]$$

In the above Equation 4, Nₛ represents an m-sequence length and has a value of 31.

Using the above scheme, the S-SCH detection operation can be performed while more reducing computation than the case using the existing 168.

However, the scheme has greatly degraded performance as compared with the existing full-search method and has very high computation complexity.

As Background Art related with the present invention, there is ‘Method and Device For Searching Cell In OFDMA System’ of Korean Patent Laid-Open No. 10-2005-0101253 (Oct. 21, 2005).

The above-mentioned technical configuration is a background art for helping understanding of the present invention and does not mean related arts well known in a technical field to which the present invention pertains.

### SUMMARY

An embodiment of the present invention is directed to a method for detecting an S-SCH in cell searching capable of reducing computation complexity for detecting the S-SCH by extracting an m1 value based on correlation between an m0 value and the m1 value in a 3GPP LET synchronization channel and a receiver using the same.

An embodiment of the present invention relates to a method for detecting S-SCH in cell searching including: detecting an m0 value corresponding to an even index in a secondary synchronization channel (S-SCH) signal having an even index; determining an m1 group defined by the m0 value; detecting an m1 value using correlation detection relation within the m1 group; and detecting a group ID using the m0 value and the m1 value.

The detecting of the m0 value may include: generating the S-SCH signal having the even index; generating a scramble signal estimated as having the m0 value by descrambing the S-SCH signal having the even index; and detecting the m0 value with the scramble signal estimated as having the m0 value.

The determining of the m1 group may include: generating the S-SCH signal having an odd signal; generating the descramble signal estimated as having the m1 value by descrambling the S-SCH signal having the odd index using the m0 value; and detecting the m1 group mapped to the m0 value in the descramble signal estimated as having the m1 value.

Another embodiment of the present invention a receiver using a method for detecting S-SCH detection in cell searching including: a demultiplexer that generates an S-SCH signal having an even index and the S-SCH signal having an odd index; a first descrambler that descrambles the S-SCH signal having the even index to generate a descramble signal estimated as having an m0 value; a first correlation detector that receives the descramble signal estimated as having the m0 value from the first descrambler to obtain the m0 value; a second descrambler that descrambles the S-SCH signal having the odd index to generate a descramble signal estimated as having an m1 value; a second correlation detector that detects an m1 group mapped to the m0 value in the descramble signal estimated as having the m1 value input from the second descrambler and obtains the m1 value using the correlation detection relation within the m1 group; and a group ID detection unit that detects a group ID using the m0 value and the m1 value.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a block configuration diagram of a receiver for detecting S-SCH in accordance with the related art;

FIG. 2 is a block configuration diagram of the receiver using the method for detecting S-SCH in cell searching in accordance with an embodiment of the present invention;

FIG. 3 is a flow chart illustrating a method for detecting S-SCH in cell searching in accordance with the embodiment of the present invention;

FIG. 4 is a diagram illustrating a table comparing computation complexity between the method for detecting S-SCH in cell searching in accordance with the embodiment of the present invention and the method for detecting S-SCH in accordance with the related art;

FIG. 5 is a diagram illustrating simulation results for analyzing performance of the method for detecting S-SCH in cell searching in accordance with the embodiment of the present invention; and

FIG. 6 is a diagram illustrating detection probability according to a moving speed of a terminal.

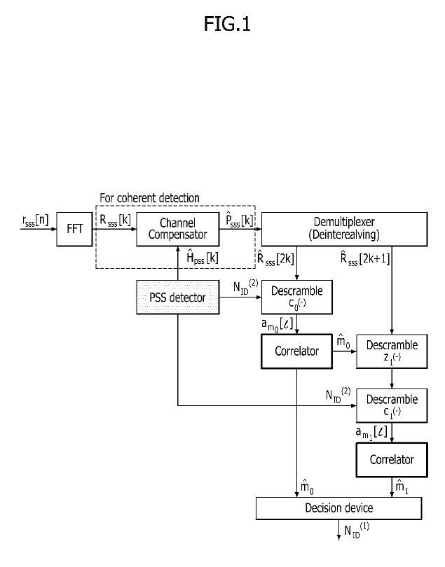

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

Hereinafter, a method for detecting S-SCH in cell searching and a receiver using the same in accordance with an embodiment of the present invention will be described with the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

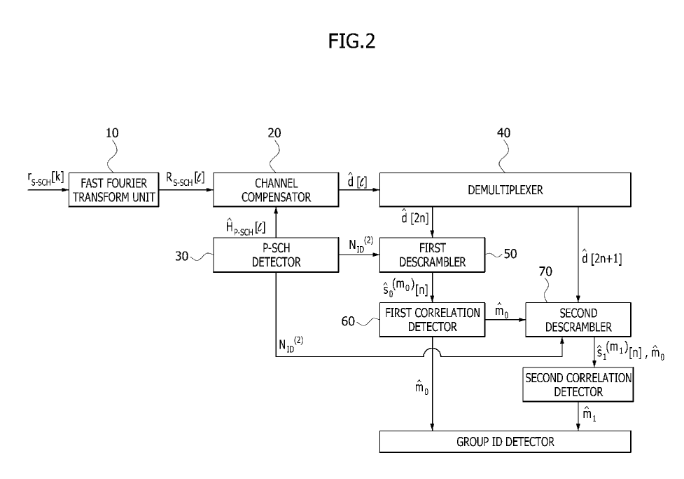

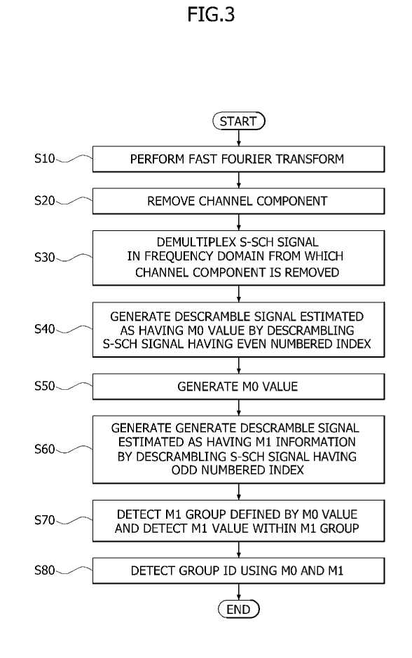

FIG. 2 is a block configuration diagram of the receiver using the method for detecting S-SCH in cell searching in accordance with an embodiment of the present invention and FIG. 3 is a flow chart illustrating a method for detecting S-SCH in cell searching in accordance with the embodiment of the present invention.

The method for detecting S-SCH in cell searching in accordance with the embodiment of the present invention groups an S-SCH signal based on an m0 value to detect an m1 value. In this case, the grouping of the S-SCH signal based on the m0 value is due to signal characteristics in LTE.

Equation 5 forms values included in an S-SCH sequence listed in a standard. As can be appreciated from Equation 5, the S-SCH sequence is configured in different ways according to whether an index is an even number or an odd number.

In this case, S₀, C₀, S₁, C₁, and Z₁ each mean an m-sequence having a length of 31 and the m0 value and the m1 value vertically present above S₀, S₁, and Z₁ are variables representing characteristics of a group ID. In this case, the m-sequence is configured by being cyclically shifted by the values. The variables represent sequence variables based on a 3GPP LTE standard document.

$$d [ 2 n ] = \{ \begin{matrix}{s}_{0}^{( {m}_{0} )} [ n ] \cdot {c}_{0} [ n ] , & in subframe 0 \\ {s}_{1}^{( {m}_{1} )} [ n ] \cdot {c}_{0} [ n ] , & in subframe 5\end{matrix} \\ d [ 2 n + 1 ] = \{ \begin{matrix}{s}_{1}^{( {m}_{1} )} [ n ] \cdot {c}_{1} [ n ] \cdot {z}_{1}^{( {m}_{0} )} [ n ] , & in subframe 0 \\ {s}_{0}^{( {m}_{0} )} [ n ] \cdot {c}_{1} [ n ] \cdot {z}_{1}^{( {m}_{1} )} [ n ] , & in subframe 5 ,\end{matrix} \qquad [ Equation 5 ]$$

Sequence characteristics corresponding to an even index can be appreciated from the above Equation 5.

That is, when C₀ and C₁ are the m-sequence defined by a sector ID that is defined in the P-SCH, a value varying in an even sequence is only m0 value. Therefore, when the m0 values are the same, it can be appreciated that the configuration of the even sequence is configured of the same sequence at all times.

Meanwhile, in Table 6.11.2.1-1 in the LTE standard document (3GPP TR 36.211 V8.7.0 (2009-05) (Evolved Universal Terrestrial Radio Access (E-UTRA): Physical Channels and Modulation), it can be appreciated that a pair of the m0 value and the m1 value defined according to the group ID are present.

It can be appreciated from Table that the m0 value has the number of 0 to 30 and therefore, the m1 value has values from a minimum of one to a maximum of seven. For example, when the m0 value has a value of 0, it can be appreciated that the value that may be included in the m1 value has only one of 7 values such as 1, 2, 3, 4, 5, 6, and 7.

This means that a candidate group that may be included in the m1 value is reduced, when the m0 value is defined. Using the sequence, the number of computations used for the correlation detection can be reduced.

Based on the characteristics, an apparatus for detecting S-SCH in cell searching in accordance with the embodiment of the present invention can be implemented.

As illustrated in FIG. 2, the apparatus for detecting S-SCH in cell searching in accordance with the embodiment of the present invention includes a fast Fourier transform unit 10, a channel compensator 20, a demultiplexer 40, a P-SCH detector 30, a first descrambler 50, a second descrambler 70, a first correlation detector 60, a second correlation detector 80, and a group ID detector 90.

The fast Fourier transform (FFT) unit 10 performs fast Fourier transform on the S-SCH signal r_{S-SCH}[k] in a time domain that is transmitted from a base station (not illustrated) to a terminal (not illustrated) to transform the S-SCH signal r_{S-SCH}[k] in the time domain into an S-SCH signal R_{S-SCH}[l] in a frequency domain. Here, k at the S-SCH signal r_{S-SCH}[k] in the time domain is a sampling index in the time domain and 1 of the S-SCH signal R_{S-SCH}[l] in the frequency domain is a frequency domain index.

The channel compensator 20 offsets the channel using channel information Ĥ_{P-SCH}[l] solid detected by the P-SCH detector 30 to remove channel components when the S-SCH signal R_{S-SCH}[l] transformed in the frequency domain by the fast Fourier transform unit 10 is input. As such, the S-SCH signal \hat{d}[l] in the frequency domain compensating for the S-SCH signal R_{S-SCH}[l] in the frequency domain is input to the demultiplexer 40.

Meanwhile, the P-SCH detector 30 performs the P-SCH detection process of the receive signal to detect the channel information Ĥ_{P-SCH}[l] and the sector ID NID⁽²⁾ of the S-SCH.

Generally, the cell searching in the LTE system is subjected to a process of combining values obtained by the P-SCH signal and the S-SCH signal. In this case, prior to detecting the S-SCH signal, the P-SCH signal is primarily detected. The P-SCH detection detects whether the P-SCH signal is received using the receive signal transmitted from the base station and is performed to detect from the corresponding cell the group ID that is included in the S-SCH signal.

Through this, the P-SCH detector 30 inputs a channel value of the S-SCH signal obtained by detecting the P-SCH signal to the channel compensator 20 and input the sector ID NID⁽²⁾ to the first descrambler 50 and the second descrambler 70.

The demultiplexer 40 performs the inverse process of the subcarrier allocation when the S-SCH signal \hat{d}[l] in the frequency domain from which the channel components are removed by the channel compensator 20. That is, the S-SCH signal \hat{d}[2n] having the even index and the S-SCH signal \hat{d}[2n+1] having the odd index are generated by demultiplexing the S-SCH signal \hat{d}[l] in the frequency domain from which the channel components are removed.

Generally, in the LTE system, the S-SCH signals are generated different from each other according to whether the index is even or odd. In this case, the S-SCH signal \hat{d}[2n] having the even index is input to the first descrambler 50 and the S-SCH signal \hat{d}[2n+1] having the odd index is input to the second descrambler 70 to improve the efficiency of the signals.

The first descrambler 50 generates a scramble signal CO(*) using the sector ID NID⁽²⁾ input from the P-SCH detector 30 and descrambles the S-SCH signal \hat{d}[2n] having the even index by the scramble signal CO(*) to generate a descramble signal Ŝ₀^{(m}^{₀}^{)[n] estimated as having the m}0 value, which is in turn input to the first correlation detector 60.

The first correlation detector 60 receives the descramble signal Ŝ₀^{(m}^{₀}⁾[n] estimated as having the m0 value from the first descrambler 50 to obtain the m0 value defined by the cell ID, which is in turn input to the second descrambler 70, the second correlation detector 80, and the group ID detector 90.

The second descrambler 70 generates scramble signals z₁(*),c₁(*) based on the sector ID NID⁽²⁾ input from the P-SCH detector 30 and the m0 value input from the first correlation detector 60 and descrambles the S-SCH signal \hat{d}[2n+1] having the odd index using the scramble signals z₁(*),c₁(*) to generate the descramble signal Ŝ₁^{(m}^{₁}^{)[n] estimated as having the m}1 value, which is in turn input to the second correlation detector 80.

The second correlation detector 80 detects the most similar candidate group signal, that is, an m1 group defined by the m0 value, which is mapped to the m0 value input from the first correlation detector 60 in the descramble signal estimated as having the m1 value input from the second descrambler 70. Through this, the number of candidates of m1 values can be reduced. Meanwhile, as described above, when the m1 group is detected, the m1 value is obtained using the additional correlation relation within the m1 group.

The group ID detector 90 finally detects the group ID by using \hat{m}₀ information input from the first correlation detector 60 and a \hat{m}₁ value input from the second correlation detector 80.

Hereinafter, the method for detecting S-SCH in the cell searching in accordance with the embodiment of the present invention will be described in detail with reference to FIG. 3.

First, the fast Fourier transform (FFT) unit 10 performs fast Fourier transform on the S-SCH signal r_{S-SCH}[k] in the time domain that is transmitted from the base station (not illustrated) to the terminal (not illustrated) (S10) to transform the S-SCH signal r_{S-SCH}[k] in the time domain into the S-SCH signal R_{S-SCH}[l] in the frequency domain.

The channel compensator 20 removes the channel components using the channel information H_{P-SCH}[l] detected by the P-SCH detector 30 when the S-SCH signal R_{S-SCH}[l] is transformed into by the fast Fourier transform unit 10 (S20). As such, the S-SCH signal \hat{d}[l] in the frequency domain compensating for the S-SCH signal R_{S-SCH}[l] in the frequency domain is input to the demultiplexer 40.

The demultiplexer 40 demultiplexes the S-SCH signal \hat{d}[l] in the frequency domain from which the channel components are removed (S30) when the S-SCH signal \hat{d}[l] in the frequency domain from which the channel components are removed by the channel compensator 20 to generate the S-SCH signal \hat{d}[2n] having the even index and the S-SCH signal \hat{d}[2n+1] having the odd index. Thereafter, the demultiplexer inputs the S-SCH signal \hat{d}[2n] having the even index to the first descrambler 50 and the S-SCH signal \hat{d}[2n+1] having the odd index to the second descrambler 70.

The first descrambler 50 generates the scramble signal CO(*) using the sector ID NID⁽²⁾ input from the P-SCH detector 30 and descrambles the S-SCH signal \hat{d}[2n] having the even index by the scramble signal CO(*) to generate the descramble signal Ŝ₀^{(m}^{₀}^{0[n] estimated as having the m}0 value, which is in turn input to the first correlation detector 60 (S40).

The first correlation detector 60 receives the descramble signal Ŝ₀^{(m}^{₀}⁰[n] estimated as having the m0 value from the first descrambler 50 to generate the m0 value defined by the cell ID, which is in turn input to the second descrambler 70, the second correlation detector 80, and the group ID detector 90 (S50).

The second descrambler 70 generates the scramble signals z₁(*),c₁(*) based on the sector ID NID⁽²⁾ input from the P-SCH detector 30 and the m0 value input from the first correlation detector 60 and descrambles the S-SCH signal \hat{d}[2n+1] having the odd index using the scramble signals z₁(*),c₁(*) to input the descramble signal Ŝ₁^{(m}^{₁}^{)[n] estimated as having the m}1 value to the second correlation detector 80 (S60).

The second correlation detector 80 detects the most similar candidate group signal, that is, an m1 group, which is mapped to the m0 value input from the first correlation detector 60 in the descramble signal Ŝ₁^{(m}^{₁}⁾[n] estimated as having the m1 value input from the second descrambler 70.

That is, the second correlation detector 80 transmits the m0 value obtained in the even index to the second correlation detector 80 of the odd index and the second correlation detector 80 uses the m0 value to reduce the candidate group of the m1 value, thereby lowering the computation complexity. As described above, when the m1 group is detected, the m1 value is obtained using the correlation detection relation within the m1 group.

This is represented by the following Equation 6.

$${\hat{m}}_{0} = {argmax}_{i , i ∈ [ 0 , 29 ]} ℛ \{ {\sum }_{n = 0}^{30} {\hat{s}}_{0}^{( {m}_{0} )} [ n ] \cdot {s}_{0}^{( i )} [ n ] \} \\ {\hat{m}}_{1} = {argmax}_{j , j ∈ {Ω}_{{m}_{0}}} ℛ \{ {\sum }_{n = 0}^{30} {s}_{1}^{( {m}_{1} )} [ n ] \cdot {s}_{1}^{( j )} [ n ] \} \qquad [ Equation 6 ]$$

In the above Equation 6, Ω̅ₘ_{₀} represents the m1 group defined by the m0 value.

The group ID detector 90 finally detects the group ID using the m0 value and the m1 value input from the first correlation detector 30 and the second correlation detector 80 (S80).

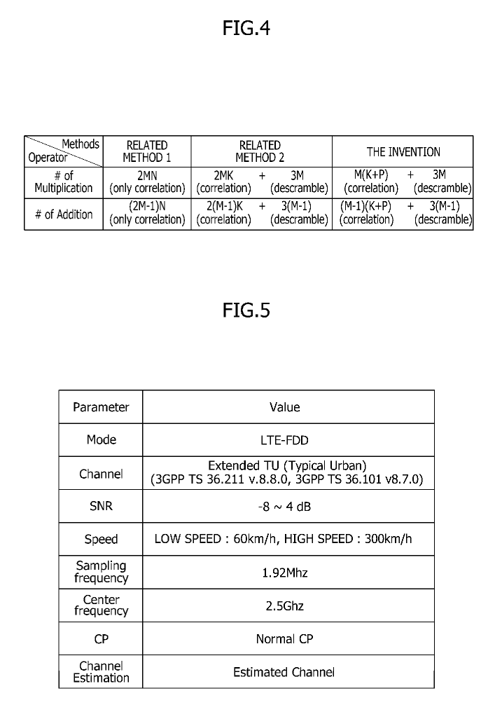

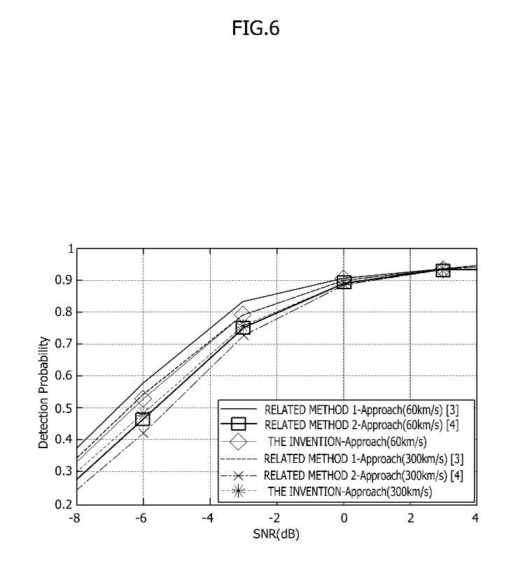

FIG. 4 is a diagram illustrating a table comparing computation complexity between the method for detecting S-SCH in cell searching in accordance with the embodiment of the present invention and the method for detecting S-SCH in accordance with the related art, FIG. 5 is a diagram illustrating simulation results for analyzing performance of the method for detecting S-SCH in cell searching in accordance with the embodiment of the present invention, and FIG. 6 is a diagram illustrating detection probability according to a moving speed of a terminal.

Referring to FIG. 4, variable M has a value of 31 as a length of the m-sequence, N represents 168 as a kind of the S-SCH sequence, K represents 30 as a value of a kind of variables that may be included in the m0 value and the m1 value, and P represents 0 to 7 as the value of a kind of variables that may be included in the m1 value within the group obtained by the mo value.

In FIG. 4, related method 1 of the full search method 1 compares all the cases and therefore, it can be appreciated that the complexity is very large.

Next, related method 2 for separately extracting the m0 value and the m1 value has the more reduced computation than that of related method 1.

Finally, the embodiment of the present invention performs the descrambling and then, separately extracts the m0 value and the m1 value to additionally group the m1 value based on the m0 value while more reducing the number of computations than that of the existing full search method, thereby performing the S-SCH detection by the most reduced computation.

Simulation is performed by LTE simulation in order to analyze the performance on the S-SCH detection in accordance with the embodiment of the present invention. To this end, simulation parameters are illustrated in FIG. 5 and an extended typical urban (TU) channel model is used to analyze the performance.

FIG. 6 is a diagram illustrating performance when a moving speed of the terminal is low speed (60 km/h) and high speed (300 km/h), respectively.

Herein, the detection probability is a probability value representing how well the cell searching is performed. Meanwhile, it means that when the probability value is 1, the cell searching is performed without error and when the probability value is 0, the error represents 100%.

In accordance with the embodiment of the present invention, when the moving speed of the terminal is low speed and high speed, it can be appreciated that a difference between the probability values of related method 1 and related method 2 is small. That is, the embodiment of the present invention can obtain the performance similar to related method 1 and related method 2 while reducing the computation complexity 10 times, thereby more efficiently detecting the S-SCH.

The embodiments of the present invention can reduce computation required to extract the m1 value by performing the grouping based on the m0 value during the process of extracting the m0 value and the m1 value and perform the S-SCH detection with the low computation.

Further, the embodiments of the present invention can efficiently perform the S-SCH detection by greatly reducing the computation complexity independent from the moving speed of the terminal.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for detecting S-SCH in cell searching, comprising:
detecting an m0 value corresponding to an even index in a secondary synchronization channel (S-SCH) signal having an even index;
determining an m1 group defined by the m0 value;
detecting an m1 value using correlation detection relation within the m1 group; and
detecting a group ID using the m0 value and the m1 value.

2. The method of claim 1, wherein the detecting of the m0 value includes:
generating the S-SCH signal having the even index;
generating a scramble signal estimated as having the m0 value by descrambing the S-SCH signal having the even index; and
detecting the m0 value with the scramble signal estimated as having the m0 value.

3. The method of claim 1, wherein the determining of the m1 group includes:
generating the S-SCH signal having an odd signal;
generating the descramble signal estimated as having the m1 value by descrambling the S-SCH signal having the odd index using the m0 value; and
detecting the m1 group mapped to the m0 value in the descramble signal estimated as having the m1 value.

4. The method of claim 3, wherein in the detecting the m1 group, the m1 group mapped to the m0 value in the descramble signal estimated as having the m1 value is detected and the m1 value is obtained using the correlation detection relation within the m1 group.

5. A receiver using a method for detecting S-SCH detection in cell searching, comprising:
a demultiplexer configured to generate an S-SCH signal having an even index and an S-SCH signal having an odd index;
a first descrambler configured to descramble the S-SCH signal having the even index to generate a descramble signal estimated as having an m0 value;
a first correlation detector configured to receive the descramble signal estimated as having the m0 value from the first descrambler to obtain the m0 value;
a second descrambler configured to descramble the S-SCH signal having the odd index to generate a descramble signal estimated as having an m1 value;
a second correlation detector configured to obtain the m1 value in the descramble signal estimated as having the m1 value input from the second descrambler using the m0 value input from the first correlation detector; and
a group ID detection unit configured to detect a group ID using the m0 value input from the first correlation detector and the m1 value input from the second correlation detector.

6. The receiver of claim 5, further comprising:
a P-SCH detector configured to detect a P-SCH signal to detect a sector ID of the S-SCH signal.

7. The receiver of claim 5, wherein the first descrambler generates the descramble signal based on the sector ID detected by the P-SCH detector to descramble the S-SCH signal having the even index.

8. The receiver of claim 6, wherein the second descrambler generates the descramble signal based on the sector ID detected by the P-SCH detector and the m0 value input from the first correlation detector to descramble the S-SCH signal having the odd index.

9. The receiver of claim 5, wherein the second correlation detector detects the m1 group mapped to the m0 value in the descramble signal estimated as having the m1 value input from the second descrambler and then obtains the m1 value using the correlation detection relation within the m1 group.
